(19) United States
(12) Patent Application Publication
(10) Pub. No.: US 2019/0082623 A1
(43) Pub. Date: Mar. 21, 2019

(54) Hurricane Speed Reducer

(71) Applicant: Adam Bednarczyk, Warszawa (PL)

(72) Inventor: Adam Bednarczyk, Warszawa (PL)

(21) Appl. No.: 15/965,659

(22) Filed: Apr. 27, 2018

(30) Foreign Application Priority Data
Sep. 21, 2017 (PL) P.422922

(51) Int. Cl. A01G 15/00; B63B 35/34

(52) U.S. Cl. CPC A01G 15/00; B63H 25/38; B63B 35/34

(57) ABSTRACT

A device for reducing hurricane speed is disclosed. In one version, it uses a floating object with a wind power generator, at least two pontoons floating on a surface of an ocean for stabilizing a horizontal deck of the floating object. The floating object also includes at least one water pump which pumps ocean water through a set of pipes to sprayers of the water, a braking fin and a steering fin wherein the water spray is used to reduce the destroying force of the hurricane.

### PRIORITY CLAIM

The instant application claims priority to Polish Patent application P.422922 filed on Sep. 21, 2017, presently pending, the contents of which are incorporated herein by reference.

### BACKGROUND OF THE INVENTION

The field of the invention is a system for reducing speed of hurricanes designed to decrease their destructive force.

The destroying force of hurricanes is caused by the high speed of air particles hitting objects on the Earth's surface. Especially high is the component of the speed resulting from rotary movement of air particles that are positioned at further distance from the center of the hurricane.

### SUMMARY

The object of the invention is a method and a device for reducing the speed of hurricanes at least to the second category in the SSHWS scale.

The essence of the invention consists in taking over the momentum of hurricane air particles by particles that are inserted to the space of hurricane, the momentum of the inserted particles is very small compared with the momentum of hurricane particles. The easiest way is to insert particles of ocean water for which the average momentum is equal to about zero.

Ocean water particles are inserted to the space taken over by a hurricane through injection, throwing out or micro explosions. The inserted water may be in the form of a stream, drops or in the gaseous state. Ocean water is in the gaseous or droplet state in this application thanks to pumping ocean water into pipes with holes. After passing through a pump, the stream of water is pumped into pipes and carried into the space taken over by the hurricane. Specially designed water sprayers may be installed on the pipe exits.

The pump or pumps and water installation consisting of pipes with water sprayers, valves are mounted to a vessel floating on a water reservoir. A ship, raft or a pontoon mounted to the ground or floating on water which have an ability to transfer solid, liquid or gas substances to the space taken over by hurricane may be used as a floating object.

The water taken from the ocean just before being taken has momentum that equals zero. While it is being taken, it gains momentum that slows down the floating object. The particles of water sprayed out by sprayers are entrained by hurricane gases and in a short time most of them reach the speed that equals to the speed of the hurricane near the pipe's outlet. So the average increase of speed of the particles sprayed out from the pipes is approximately the same as the speed of the hurricane.

For example, let us find the mass of the sprayed drops of water that would take over the whole kinetic energy of hurricane Katrina so that that water particles at the final moment of their acceleration reach the average speed of category 2 hurricane, that is 60 m/s. The kinetic energy of hurricane Katrina was 116 Tera joules. The takeover of 116 TJ of energy means that for an unknown mass M having the beginning speed of zero to reach the final speed equal 60m/s the unknown mass is:

1/2×M×(60 m/s)exp.2=116×10exp12[J]

M=6,5×10exp.10[kg]=65 min. ton

Let us assume that we have one week that is T=604800[s] for slowing down a hurricane with the energy of hurricane Katrina using the above amount of the mass of water. Let us find the output of the pump that guarantees adding of mass M to the mass of the hurricane during assumed time.

6.5×10exp.10[kg]=604800[s]×R R means the output of the pump

R=107473 [kg/s]

The output (R) is about five times lower than that of the pump designed by the U.S. Army Corps of Engineers having the output of 150000 gallons of water per second, which equals 573000 kg/s. The pump rate allows lowering the indispensable time five fold to reduce the speed of hurricane from category five to category two in the SSHWS scale. When the above pump is used, the reduction from category five to category two will take less than two days. The above calculation shows methodology.

It does not take into account the speed of the floating object or changes in kinetic energy in a form of a quadratic function, the efficiency of taking over the kinetic energy of the hurricane by the drops of ocean water. From the practical and financial points of view, numerous ships with numerous pumps on each ship may be used to destroy the dangerous hurricane. While colliding with the particles of water, the particles of hurricane gases reduce their speed and hence the drops of water sprayed through the hydraulic system constitute a kind of a brake in the hurricane's movement reducing its speed

### BRIEF DESCRIPTION OF THE DRAWINGS

The invention together with the above and other objects and advantages will be best understood from the following detailed description of the preferred embodiment of the invention shown in the accompanying drawings, wherein:

FIG. 1 depicts an overview of an embodiment of the system.

### DETAILED DESCRIPTION

The foregoing summary, as well as the following detailed description of certain embodiments of the present invention, will be better understood when read in conjunction with the appended drawings.

A set of subassemblies of the Hurricane Speed Reducer (the device):

1. A ship

2. Pontoon situated on the left side

3. Extension arm of the pontoons on the left and on the right side

4. Wind current generator

5. Water pump

6. Supplying pipe

7. Dividing pipe for sprayer

8. Spraying pipes

9. The pipe with a filter supplying water

10. Pontoon on the right side

11. Mounting plate

12. Rotary braking fin

13. Steering fin

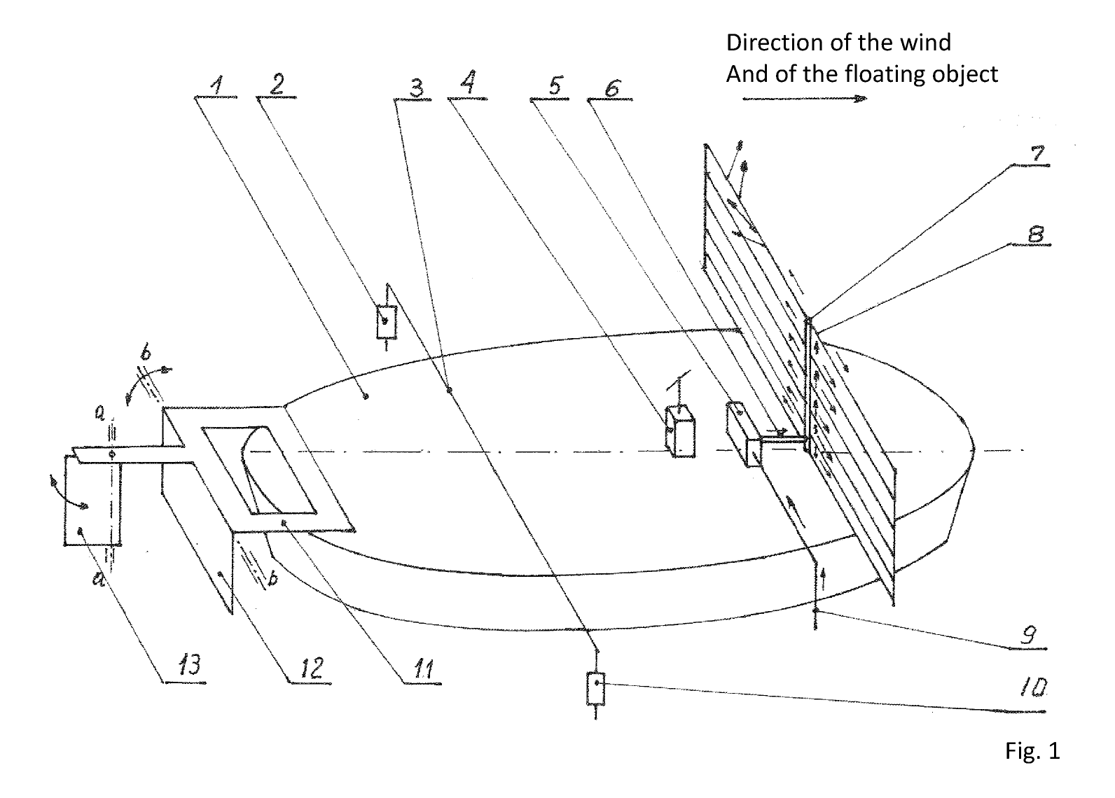

Turning to FIG. 1, the device of the hurricane speed reducer is shown by the example of a sea ship 1 moving in the direction shown. The presented solution may be applied on any floating object having the appropriate displacement and allows independent movement and reduction of the hurricane speed using only the kinetic energy of hurricane particles.

If a sea ship already built is used, the ship must be adapted to the new atmospheric conditions and the requirements resulting from this patent application. Water pumps 5 should be mounted on the sea ship and these pumps must be propelled by combustion engines or electrical engines. A water pump draws sea water through pipe 9 equipped with a filter and next, water is pumped using a supplying pipe 6 into a dividing pipe 7 under pressure. Dividing pipe 7 is connected with spraying pipes 8. Spraying is carried out by micro holes in spraying pipes 8 (there are six horizontal pipes on the attached drawing) that should be set perpendicularly to the direction of air movement. It is useful when the spraying is carried out upwards or in slant upper direction and in the direction opposite to the movement of the hurricane. Spraying upwards is beneficial as it increases the time of small drops of water falling down to the surface of the ocean. Electric energy may be generated by a combustion engine on the ship or by wind power generator 4. An extension arm 3 is mounted to the deck of the ship with pontoon 2 and pontoon 10 attached to the ends of extension 3. These two pontoons increase the ship's stability.

The efficiency of slowing down is higher thanks to spraying small drops of water at small velocities of the ship that is moving along the direction of the speed of the hurricane particles hitting the ship. A braking fin 12 that is rotary and attached to the mounting plate 11 with the ability of rotation around the geometric axis b-b is used to slow down the ship. Steering fin 13 is used to change the direction of its movement by pivoting around the axis a-a.

Floating objects other than sea ships must be brought into the area of the hurricane by sea ships or other handling equipment to be able to independently move in the hurricane zone.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting, but are instead exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the terms “comprising” and “wherein.” Moreover, in the following claims, the terms “first,” “second,” and “third,” are used merely as labels, and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

The embodiment of the invention in which an exclusive property or privilege is claimed is defined as follows:

1. A method of reducing hurricane speed by a hurricane speed reducer is characterized in that particles with small momentum or momentum equal to zero are inserted to space occupied by the hurricane in order to slow down said hurricane.

2. A method of reducing hurricane speed according to claim 1 is characterized in that the particles that are inserted may be in the solid state or may be liquid or gaseous particles.

3. A method of reducing hurricane speed according to claim 1 is characterized in that particles in the solid state or liquid or gaseous substances are introduced by injecting, spraying, throwing or by explosions.

4. A method of reducing hurricane speed according to claim 1 is characterized in that equipment comprising ships, rafts, pontoons from which solid, liquid and gaseous substances are inserted to space occupied by said hurricane, may be used to slow down said hurricane speed.

5. A method of reducing hurricane speed according to claim 4 characterized in that the equipment used for slowing down uses braking fins.

6. A method of reducing a hurricane according to claim 4 characterized in that slowing equipment is mounted to ground.

7. A method of reducing hurricane speed according to claim 6 characterized in that slowing equipment is additionally equipped with sails slowing down the movement of hurricane particles.

8. A method of reducing hurricane speed according to claim 1 wherein ocean water particles are inserted to the space occupied by a hurricane to slow down the hurricane speed.

9. A device for reducing hurricane speed characterized in that a floating object that is equipped with a wind power generator, at least two pontoons floating on a surface of an ocean for stabilizing a horizontal deck of the floating object and at least one water pump pumping ocean water through a set of pipes to sprayers of the water, a braking fin and a steering fin wherein the water spray is used to reduce the destroying force of the hurricane.

10. The device for reducing hurricane speed according to claim 9 characterized in that pipes with micro-holes or sprayers are set perpendicularly to the direction of the movement of the hurricane.
